(19) United States
(12) Patent Application Publication
(10) Pub. No.: US 2026/0105178 A1
(43) Pub. Date: Apr. 16, 2026

(54) Adaptive Differential Privacy

(71) Applicant: Hewlett Packard Enterprise Development LP, Spring, TX (US)

(72) Inventors: Pavana Prakash, Milpitas, CA (US); Kanchu Kiran, Fort Collins, CO (US); Dejan S. Milojicic, Palo Alto, CA (US); Eitan Frachtenberg, Portland, OR (US)

(21) Appl. No.: 18/916,193

(22) Filed: Oct. 15, 2024

(51) Int. Cl. G06F 21/62

(52) U.S. Cl. CPC G06F 21/6227

(57) ABSTRACT

Query-adapted differential privacy is provided herein. Characteristics of a received query, such as characteristics of the querier, characteristics of the data requested, or both are used to dynamically determine an appropriate amount of noise to introduce into a results dataset of the data query. In this manner, the results dataset may provide a proper balance between data privacy leakage prevention and query accuracy, specifically for the received query.

### BACKGROUND

The present disclosure relates generally to adaptive differential privacy. More specifically, the present disclosure relates to providing adaptive noise insertion in data query results based upon characteristics of the data query.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the digital world, ever-increasing amounts of data may be available for access and use. With the increase in data comes an increased need to protect the data and the underlying information that may be gleaned from the data. Differential privacy techniques aim to do just that by limiting the release of private information to preserve the privacy of individuals represented in the data. Specifically, differential privacy techniques use pre-defined static privacy variables to identify and insert noise into supplied datasets. The pre-defined static variables involved in determining the amount of noise to insert include a static privacy budget estimate (epsilon) that enables an operator to statically set how private the dataset should be and/or a probability deviation (delta) allowing a deviation from the privacy budget guarantee. A sensitivity metric measures how much the output of a query or function can change when a single individual’s data is added or removed from the dataset. The sensitivity metric quantifies the impact of individual data points on the query output (dataset) and serves as a parameter in determining the amount of noise useful to achieve privacy guarantees. For example, lower sensitivity values may imply that individual data points have less influence on the query output, requiring less noise to be added for privacy protection. In contrast, higher sensitivity values may indicate that individual data points have relatively more influence on the query output, requiring more noise to maintain privacy while preserving data utility or accuracy.

The inserted noise helps to ensure preserved privacy by introducing randomness that enables those accessing the dataset to learn useful information about the population represented by the dataset, while restricting an ability to learn information about an individual in the population. While the inserted noise helps to ensure preserved privacy, this does typically come with a tradeoff in reduced query accuracy resulting from the inserted noise.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a diagram, illustrating a Query-Adapted Differential Privacy (QADP) system, in accordance with aspects of the present disclosure;

FIG. 2 is a schematic diagram, illustrating a range of Query-Adapted datasets, in accordance with aspects of the present disclosure;

FIG. 3 is a flowchart, illustrating a process for performing Query-Adapted Differential Privacy (QADP), in accordance with aspects of the present disclosure;

FIG. 4 is a flowchart, illustrating a process for performing Query-Adapted Differential Privacy (QADP) using sensitivity estimates of a query, in accordance with aspects of the present disclosure;

FIG. 5 is a flowchart, illustrating a process for performing a sensitivity evaluation for a data query based upon an adjacent dataset analysis, in accordance with aspects of the present disclosure; and

FIG. 6 is a diagram, illustrating an example use case of the Query-Adapted Differential Privacy (QADP) applied to different queries and/or queriers, in accordance with aspects of the present disclosure.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As mentioned above, “Differential Privacy” refers to techniques that mitigate private data leakage, by supplying datasets that attempt to ensure that data receivers are unable to learn anything about an individual while enabling these data receivers to learn useful information about a population represented by the dataset. It does this by modifying query results for improved privacy, attempting to achieve query results where the same conclusions may be observed in supplied datasets independent of whether any individual is present or not in the dataset. When an individual’s data in the dataset does result in an ability to observe different conclusions, this may indicate that the individual is identifiable in the dataset, potentially exposing private information about the individual. To mitigate this potential private information leakage, statistical noise may be introduced, resulting in the randomness that may reduce the ability to make observations with respect to an individual in the dataset.

The amount of introduced noise has traditionally been based on prescribed functions, attempting to ensure that the probability of getting a certain response is less dependent on the private identifying information. Unfortunately, however, since the differential privacy functions and their parameters are predetermined to guarantee a provably tight bound on information leakage, the amount of introduced noise may be overly burdensome for particular applications, resulting potentially in overly conservative protection, and leading to less accurate query results (e.g., having more noise than useful for the desired application). Further, in some instances, overly aggressive protection may lead to resource waste and increased latency.

Accordingly, the present disclosure relates generally to Query-Adapted Differential Privacy (QADP) that adapts (e.g., at query time) an amount of introduced noise for particular applications. More specifically, the present disclosure relates to adapting an amount of Differential Privacy noise that is inserted into a results dataset of a query based upon characteristics of the query (e.g., specific features of the query and/or “querier” (e.g., an entity or user) that is requesting the query results dataset).

For example, for a given query, if the querier is a trusted source, the noise can be relatively low when compared to a query submitted by a querier that is not a trusted source. Further, a quantification of how information would be leaked by an unmodified response to a specific query may be used to identify a noise adjustment specifically tailored for this query. For example, if the query leaks no data (e.g., because it is a very common response), it may be feasilble to add little to no noise, especially when compared to a query that would leak more data.

In this manner, the current techniques adapt an amount of Differential Privacy noise that is introduced into datasets, tailoring the Differential Privacy to the particular application and/or query. Further, a type of introduced noise may be adjusted for particular applications. For example, Gaussian noise (a type of random signal noise following a normal distribution) may be used in more flexible applications that do not follow a strict privacy definition, while Laplacian noise (a type of random signal noise following a Laplacian distribution, with scaling parameter) may be used in applications with such strict privacy definition. These adaptable noise techniques result in data solutions (e.g., data dependent and/or data providing solutions, such as databases and/or machine learning (ML) models) that offer more privacy than unprotected data solutions, while also providing more accurate data than data solutions that implement full-blown Differential Privacy guarantees. Further, privacy and accuracy tradeoffs may be tuned for particular applications, such as by particular customers and/or based upon particular trust levels with respect to queriers receiving dataset results.

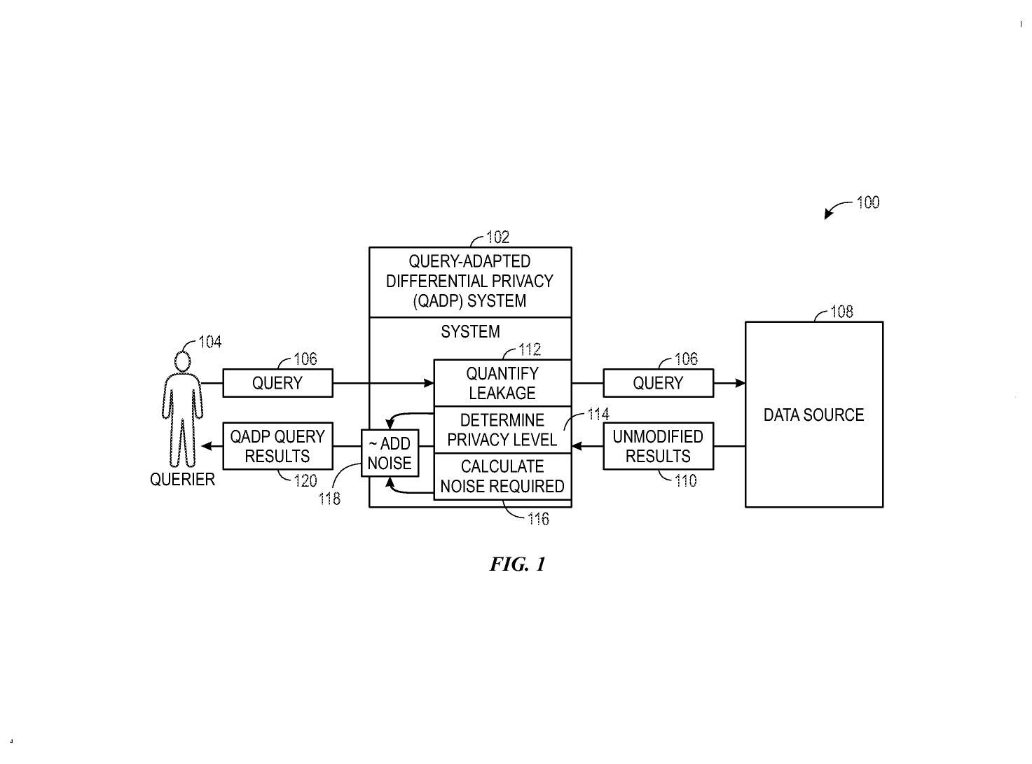

With this in mind, FIG. 1 is a diagram, illustrating a system 100 including a Query-Adapted Differential Privacy (QADP) system 102 that provides QADP, in accordance with aspects of the present disclosure. As illustrated, a querier 104 may provide a query 106 requesting a particular dataset (data), such as, from a data source 108, which may include a web server, database, or other data providing entity. In some cases, the querier 104 may be a user, while in other cases the querier 104 may be another entity, such as a personal computer, server, and/or electronic service requesting data. As used herein, the query 106 may be a database query, such as a Structured Query Language (SQL) database query or any other type of electronic request for data.

The query 106 may be provided and/or intercepted by the QADP system 102, which is tasked with introducing an adaptive amount of Differential Privacy noise into results of the query 106 based upon particular characteristics of the query 106, such as characteristics of the source of the query 106 (e.g., the querier 104) and/or what is requested by and/or would be returned in a results dataset of the query 106. As illustrated, the QADP system 102 may receive the query 106. The QADP system 102 may cause execution of the query 106 against the data source 108 resulting in receiving unmodified results 110 of the query 106. At query-time, the QADP system 102 may perform analysis, such as analysis 112 to quantify a leakage that would result from providing the unmodified results 110 of the query 106 to the querier 104. In some cases, the amount of leakage may be dependent on a scale of the data. For a relatively large scale of data, there may be less data leakage, as it may be more difficult to ascertain information about any one user, as there may be a significant number of users, at least some having similarly associated data. However, when the data scale is relatively small, having fewer users represented in the data, this may indicate more potential for data leakage as there may be less overlapping data amongst users in the data.

Further, analysis 114 may be performed to determine a desired privacy level for the query 106. The desired privacy level may dynamically change based upon one or more factors. For example, desired privacy levels may be dynamically defined based upon a trust level of the querier 104, based upon the type of data from the data source 108, based upon result dataset types and/or amounts, based upon user-defined privacy rules, based upon regulatory rules, based upon an amount of private data identified to be leaked from data query results, and/or other factors. Based upon the analysis (e.g., analysis 112 and/or analysis 114) a calculation 116 of an amount of noise to introduce is performed. For example, one or more lookup tables may be accessed to identify an amount of noise to introduce corresponding to the quantified leakage of analysis 112 and/or the determined privacy level of analysis 114.

The QADP system 102 may dynamically add noise 118 to the unmodified results 110 to provide QADP via QADP query results 120. As mentioned above, the QADP query results 120 may provide query 106 results that are dynamically tailored to characteristics of the query 106. In this manner, a more beneficial/desirable amount of noise may be introduced, striking a more suitable tradeoff between dataset accuracy and privacy for a given application and/or query 106.

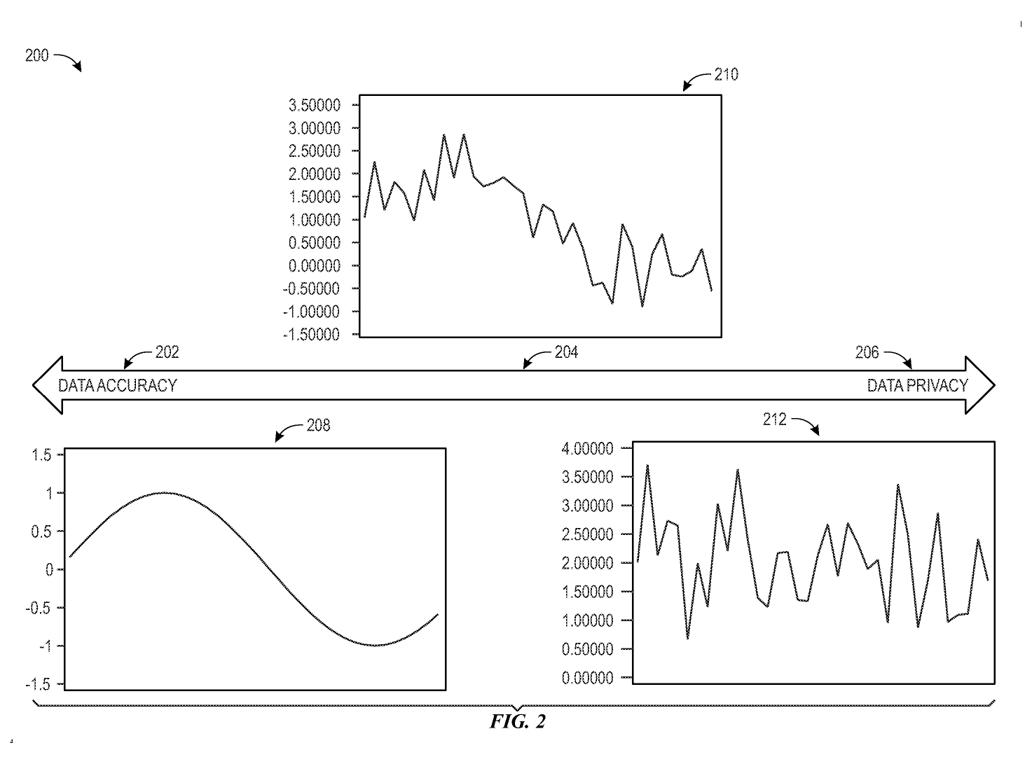

FIG. 2 is a schematic diagram, illustrating a range 200 of Query-Adapted datasets, in accordance with aspects of the present disclosure. As illustrated, on side 202 of the range 200, the dynamic adjustment of noise favors query accuracy over data privacy. For instance, unmodified dataset 208 illustrates a dataset where no noise is introduced, providing extremely accurate dataset results, but also potentially providing little to no guarantee against private data leakage. Such dynamic adjustment corresponding to side 202 may be appropriate in a number of instances. For example, if the querier is highly trusted and/or it is known that unmodified query results will not divulge sensitive private data (e.g., because no single individual’s presence in the dataset results in new observations and/or because the dataset results are well-known and/or the query is commonly requested), dynamic noise adjustments favoring query accuracy over data privacy may be more appropriate.

In the middle 204 of the range 200, the dynamic noise adjustment may indicate an amount of noise to add such that query accuracy and data privacy may be balanced. For instance, example dataset 210 has been modified to add noise (e.g., data randomness), resulting in data spikes within dataset 210. This randomness may provide relatively more privacy when compared to unmodified dataset 208, while also providing a balance of the privacy with query accuracy. For example, as illustrated, dataset 210, while having data spikes, also still follows the basic distribution shape of the unmodified dataset 208. Thus, the dataset 210 may retain relatively more query accuracy when compared with datasets adjusted based upon side 206 of the range 200. Dynamic noise adjustments corresponding to the middle 204 may be appropriate when both data privacy and query accuracy are of balanced concern. For example, a querier may have a level of trust that is not fully trusted but is also not “untrusted” and/or “unknown.” In such a case privacy may be a concern, but may be of lesser concern relative to an untrusted/unknown querier. This may suggest that the dynamic adjustment should correspond to a location between side 202 and side 206.

On side 206, data privacy is favored more than query accuracy. For instance, results dataset 212 (e.g., a set of query results), when compared with results dataset 210, includes relatively more introduced noise, resulting in larger data spikes and reduced resemblance to the distribution shape of the unmodified dataset 208. Thus, the query accuracy is reduced relative to results dataset 210. However, privacy is increased, as the randomness helps decrease the likelihood that a particular user being present in the dataset 212 results in additional observations, which would mean that the user could be distinguished in the results dataset 212. Such adjustments may be beneficial in cases where data privacy is relatively more useful, such as when results and/or datasets include data that is sensitive and/or when an untrusted/unknown querier is requesting the query results.

As may be appreciated, the flexible nature of the dynamic adjustments to an amount of noise to introduce in query results datasets may provide more suitable results for individual applications. Indeed, the amount of noise may be dynamically adjusted to specifically adjust the tradeoff between query accuracy and data privacy based upon the particular query characteristics and application of the query. While three levels of adjustment (e.g., side 202, middle 204, and side 206) have been discussed, virtually any number of levels of adjustment may be implemented to provide tailored QADP results for datasets for different applications. In this manner, returned results datasets may strike an optimized balance between query accuracy and data privacy for any number of different scenarios and/or applications.

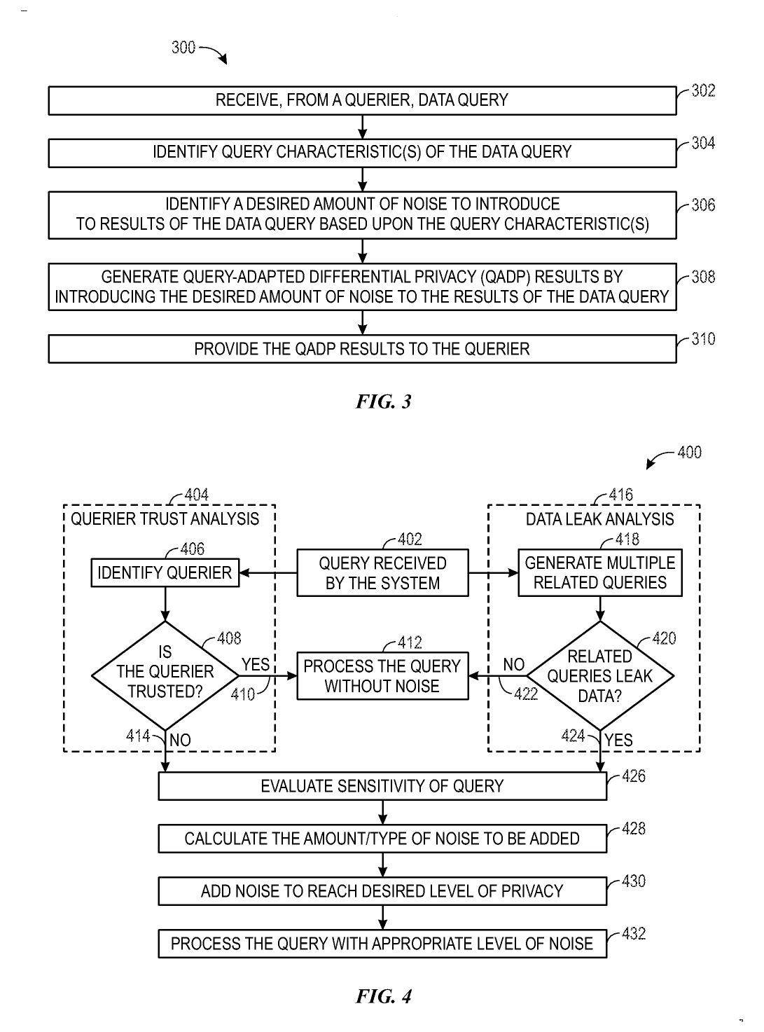

FIG. 3 is a flowchart, illustrating a process 300 for performing Query-Adapted Differential Privacy (QADP), in accordance with aspects of the present disclosure. As mentioned above, the QADP process inserts a specific amount of noise into results (e.g., “results datasets” and/or “query results”), where the specific amount of noise is tailored to characteristics of the query, such as the querier and/or what is included in the unmodified query results dataset.

Process 300 begins by receiving a data query (block 302). The data query may be received from a querier, which may be a user, computer, or software that is requesting results for the data query. The data query may be any type of electronic data request such as an SQL query, specifying criteria of data to return in the query results.

Query characteristics of the data query are identified (block 304). For example, the query characteristics may include characteristics of the querier providing the data query. In some instances, the query characteristics may include characteristics of the data requested/criteria of data to return specified in the data query. In some instances, the query characteristics may include characteristics of the data contained in the results of the data query after the data query is executed.

A desired amount of noise to introduce to the data query results may be identified based upon the identified query characteristics (block 306). In some instances, a lookup table may be used to identify the desired amount of noise associated with the particular query characteristics. For example, the lookup table may be queried using a given trust level of the querier, a level of commonality of the data query indicating how often the data query is run and/or how often the data results of the data query are provided, and/or a level of sensitivity of the data results of the data query. In some instances, the amounts of noise provided by the lookup table may be adjusted based upon user-input describing particular preferences, such as a priority of query accuracy vs. data privacy. These particular preferences may be set for particular data sources, particular portions of a data source, and/or globally across all data sources. For example, for highly sensitive data, such as private demographic and/or financial data, the particular preferences may be set to prioritize privacy over accuracy. Additionally the particular preferences may be set for particular types of queriers. For example, the particular preferences may be set to prioritize accuracy over privacy for particular trusted queriers, such as data owners (those whose information is stored in the data), enabling data owners to have a more accurate view of their data.

Once the desired amount of noise is identified, QADP data query results may be generated by introducing the identified desired amount of noise to results of the data query (block 308). For example, the desired amount of noise (e.g., random data) may be inserted into the results dataset of the data query, thus providing differential privacy to the results.

After generation of the QADP data query results, the QADP data query results may be provided back to the querier (block 310). In this manner, the querier may receive results for the data query requested by the querier, while ensuring a level of differential privacy tailored to the particular data query/querier. Thus, in contrast to data query results that are overly privatized (and thus under-accurate) or over-accurate (and thus under-privatized), the QADP data query results may strike a balance between query accuracy and data privatization based specifically on the particular data query and/or querier.

FIG. 4 is a flowchart, illustrating a process 400 for performing Query-Adapted Differential Privacy (QADP) using sensitivity estimates of a query, in accordance with aspects of the present disclosure. As mentioned above, a sensitivity metric measures how much the output (e.g., results dataset) of a query or function can change when a single individual’s data is added or removed from the dataset. The sensitivity metric quantifies the impact of individual data points on the query output (dataset) and serves as a parameter in determining the amount of noise useful to achieve privacy guarantees. For example, lower sensitivity values may imply that individual data points have less influence on the query output, requiring less noise to be added for privacy protection. In contrast, higher sensitivity values may indicate that individual data points have relatively more influence on the query output, requiring more noise to maintain privacy while preserving data utility or accuracy. Process 400 adapts the amount of noise introduced into QADP data query results based upon this sensitivity metric.

The process 400 begins with receiving a query requesting data (e.g., data query results). The data query may be received from a querier, which may be a user, computer, or software that is requesting a results dataset for the data query. The data query may be any type of electronic data request such as an SQL query and/or function, specifying criteria of data to return in a results dataset.

In some instances, it may be beneficial to identify a trust level of queriers, which may be used to dynamically impact the QADP. For example, trusted queriers may receive data query results without differential privacy constraints, while less trusted and/or untrusted queriers may receive QADP results that include noise for enhanced privacy. Accordingly, to afford such a feature, an optional querier trust analysis 404 may be performed.

The querier trust analysis 404 identifies the querier (block 406). For example, the querier may provide identifying data, such as an Internet Protocol (IP) address, login credentials, or other identifying information that may indicate who the querier is.

At decision block 408, a determination is made as to whether the querier is trusted. Many different factors may be considered in determining whether the querier is trusted. For example, sets of trusted organizations, users, and/or entities for a particular dataset and/or data source may be pre-defined, such as by a data source administrator. In some instances, the querier may be trusted if the querier is represented in the dataset. For example, census data of a particular tribe may be trusted when the data source includes data of the tribe members, but not when the data source is un-related to the tribe members (e.g., a stock exchange data store). Trust rules may be established and stored in a data store associated with the QADP system 102, enabling dynamic determination of trust with respect to particular queriers.

In instances where QADP policies establish that querier trust results in no need for differential privacy, the data query results may be provided without adding additional noise. Thus, when the querier is trusted (arrow 410), the data query may be processed (e.g., data query results obtained and provided by to the querier) without adding noise (block 412). However, when the querier is not trusted (e.g., has less than full trust) (arrow 414), additional query analysis may be performed to determine an amount of noise to add for differential privacy.

In some instances, QADP policy may be implemented such that data query results for data queries are dynamically adjusted with noise levels based upon whether the data query leaks data. For example, data queries that do not leak data may be provided without differential privacy constraints, while results of data queries that do leak data are adapted with introduced noise to preserve data privacy. Accordingly, to afford this feature, an optional data leak analysis 416 may be performed.

The data leak analysis 416 may determine whether the data query leaks data. To do this, the data leak analysis 416 may include generating multiple related queries to the data query (block 418). The related queries apply the data query to data sources (D’) where one data item adjustment is made to the queried data source (D) to determine whether data leakage may be observed via these related queries.

A determination is made as to whether the related queries leak data (decision block 420). To do this, the related queries are executed to determine whether new observations are available based upon the changes in the related queries. In some instances, the determination may be probablistic rather than absolute and/or binary. In other words, the determination, rather than difinitively determining whether data is leaked, may determine whether leaks are possible, looking at a probability of leaks from the query.

If no data leaks are identified and/or the probability of data leaks is below a threshold, the releated queries may be determined to not leak data (arrow 422), and the data query may be processed without adding noise for differential privacy (block 412). However, when new observations are available from the related queries (i.e., the probability of data leaks from the queries is above the threshold and/or data leaks are identified), the related queries may be determined to leak data (arrow 424) and additional query analysis may be performed to determine an amount of noise to add for differential privacy.

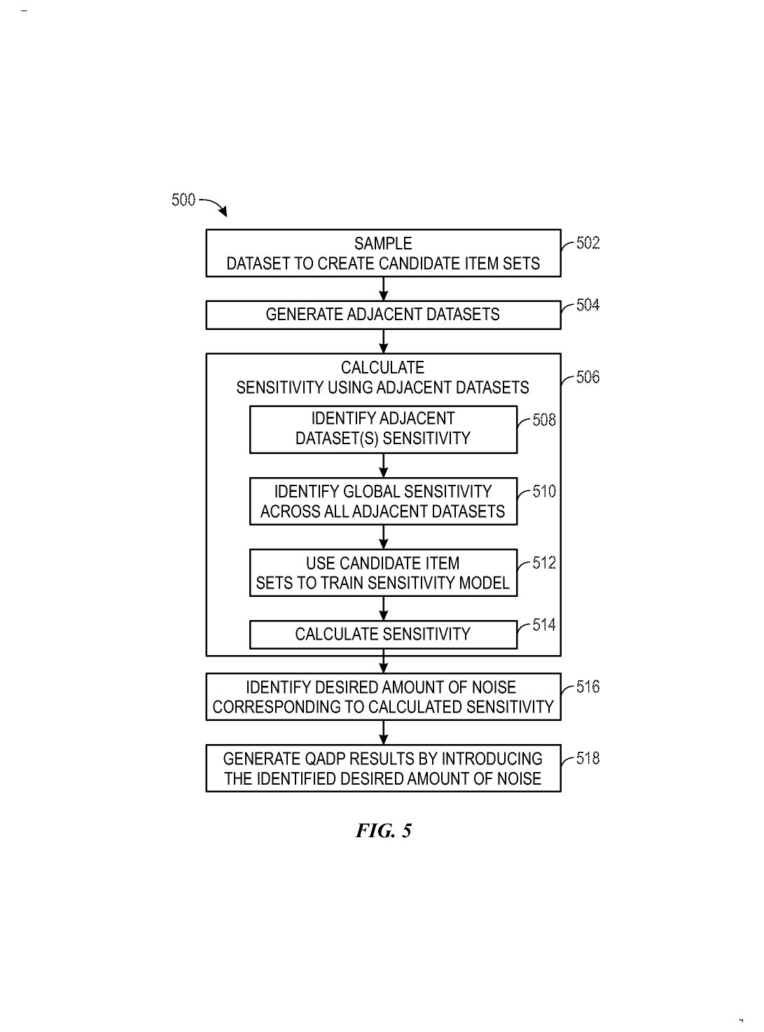

When the querier is not trusted (arrow 414) and/or the related queries leak data (arrow 424), subsequent analysis is performed to identify an amount of noise to add to the data query results. For example, the sensitivity of the data query is evaluated, to identify a sensitivity metric for the data query (i.e., how sensitive the data query is) (block 426). The sensitivity may be based, in some instances, on how much data leak is observed by the related queries (e.g., from decision block 420). A process for such determination of sensitivity is described in more detail below with respect to FIG. 5.

The way sensitivity is evaluated may change based upon certain characteristics of the implementing system. For example, when the system includes a relatively high-performance (e.g., faster) machine for performing the sensitivity analysis, sensitivity may be analyzed in a more granular manner, looking at more related queries and associated data leakage. In contrast, when the system includes a relatively lower-performance (e.g., slower) machine for performing the sensitivity analysis, a less-granular approach may be used (e.g., looking at fewer related queries and/or relying on a user-defined sensitivity metric).

Based upon the sensitivity evaluation, an amount of noise to be added to the data query results is calculated (block 428). Further, a type of noise to be added may be determined. The amount of noise to add may be proportional to the sensitivity of the query (e.g., the sensitivity metric) and/or risk associated with a level of trust of the querier. In other words, the more sensitive the data query is and/or higher risk associated with a level of trust of the querier, the more noise that may be added.

Further, the type of noise to be added may be selected based upon a privacy definition for the data query. For example, Gaussian noise (a type of random signal noise following a normal distribution) may be used in more flexible applications that do not follow a strict privacy definition, while Laplacian noise (a type of random signal noise following a Laplacian distribution, with scaling parameter) may be used in applications with such strict privacy definition.

A results dataset resulting from execution of the data query may be modified to provide an adaptable level of differential privacy specific to the characteristics of the data query. Specifically, the calculated amount and/or type of noise to be added is then added to the results dataset of the data query (block 430).

Once the appropriate amount and/or type of noise is added to the results dataset, the data query processing is completed with the appropriate noise (block 432). Specifically, the modified results dataset (i.e., including the added noise) is returned in response to the received query (e.g., of block 402). Thus, the querier may receive a results dataset that is tailored to provide an appropriate level of privacy versus query accuracy for the particular data query/querier and any user-defined parameters/criteria.

As mentioned above, the amount of noise to be added may be derived based upon a sensitivity metric specifically derived for the received data query. However, in some scenarios, it may be difficult to provide a global sensitivity estimation, especially when large datasets are involved and/or complex sensitivity analysis techniques are used. Accordingly, in some instances, especially when providing on-the-fly and/or online analysis, it may be beneficial to provide pre-processing and/or pre-trained modelling for identifying sensitivity analysis and, thus, the amount of noise to add to a results dataset for a given data query. FIG. 5 is a flowchart, illustrating such a process 500 for performing a sensitivity evaluation for a data query based upon an adjacent dataset analysis, in accordance with aspects of the present disclosure.

Process 500 begins with sampling the dataset to create candidate item sets (block 502). A complete dataset (e.g., before filtering via the specified criteria) associated with a data query is sampled to identify candidate item sets associated with entities (e.g., users) represented in the dataset (D). The candidate item sets, for example, may follow the format of {user1: item1, item2, …, item n} where the items describe a data field associated with a particular user.

Adjacent datasets are generated from the candidate item sets (block 504). To generate the adjacent datasets, neighboring datasets/database pairs are formed by modifying a candidate item set of the complete dataset. For example, empirical process theory tools may be used to efficiently create dataset variations. For example, a neighboring/adjacent dataset may be generated by 1) removing one item from each user’s candidate item set, 2) replace one item with a new item in each user’s candidate item set, and/or 3) delete one user entry from the neighboring dataset prior to creating the list of candidate item sets.

The sensitivity is calculated using the adjacent datasets (block 506). Specifically, for adjacent datasets (D and D’) a function f’s sensitivity is quantified as ∆(D, D') = ∥f(D) − f(D’)∥ (block 508). In other words, f’s sensitivity is defined based upon a difference caused by the differences in the neighboring datasets.

A global sensitivity is then calculated (block 510) based upon the adjacent dataset sensitivities. Specifically, the global sensitivity may derived as the maximum of the adjacent dataset sensitivities across all adjacent dataset pairs.

A sensitivity model may be trained based upon the candidate item sets (block 512). For example, the data query may be applied to the candidate data items and the associated sensitivities and/or the global sensitivity may be used to train the sensitivity model. Specifically, a Euclidean norm (“L2-norm”), which is the calculated distance of a vector coordinate (D’) from the origin of the vector space (D), is calculated between prediction rate vectors for adjacent queries (e.g., the data query applied to adjacent datasets).

This enables the candidate item sets to be utilized to calculate sensitivity (block 514) analysis of the data query. Specifically, the sensitivity is calculated by averaging the L2-norm values across all users. The resulting value provides a sensitivity metric for the data query.

The amount of noise to introduce is identified based upon the calculated sensitivity (block 516). Specifically, sensitivity metrics for adjacent datasets are collected and compared with recommended outcomes (e.g., user-parameters indicating a level of recommended privacy and/or query accuracy). The recommended outcomes may include user-defined desired privacy indications for particular data.

Based upon the comparison and difference between the sensitivity and the recommendation outcomes may be ascertained and an amount of noise corresponding to this difference may be identified. The identified amount of noise may be inserted into the results dataset of the data query (block 518).

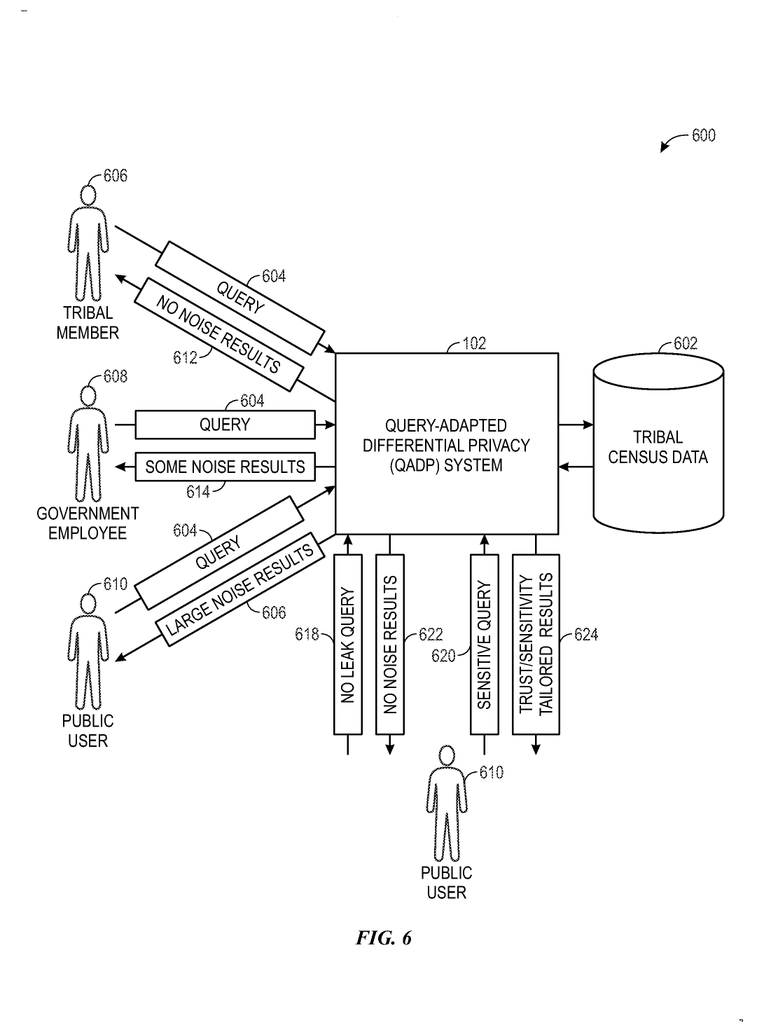

FIG. 6 is a diagram, illustrating an example use case 600 of the Query-Adapted Differential Privacy (QADP) applied to different queries and/or queriers, in accordance with aspects of the present disclosure. As mentioned above, noise introduced via QADP may be adapted based upon a particular querier and/or particular data leak characteristics of the data query itself. The use case 600 provides an example of different adaptations that may occur based upon these characteristics.

In the use case 600, a complete data set includes Tribal Census Data 602, providing demographic information for members of a tribe. The QADP system 102 is tasked with providing results datasets with an adapted level of differential privacy based upon query characteristics associated with queries that it receives. This may be particularly useful for a small tribe where the tribal census data 602 has a small scale, which may tend to render the Tribal Census Data 602 more sensitive (e.g., exposing a particular tribal member by providing data that is attributable to a specific tribal member. Taking a look first at the effects of trusted queriers, an identical query 604 may be provided by three separate queriers (e.g., tribal member 606, government employee 608, and public user 610). Depending on a trust policy, which may change, tribal member 606, as part of the tribe represented by the Tribal Census Data 602, may be identified as fully trusted queriers. Thus, when the query 604 is sent by the fully trusted tribal member 606, the QADP system 102 may receive and return the results dataset with no added noise (results 612). In this manner, the tribal member 606 may receive highly accurate results void of any added noise. If the results 612 were not adapted for the trusted tribal member 606, the tribal member may not be able to receive accurate data regarding the member’s own tribe, making the data less useful.

The government employee 608 may be identified as a somewhat trusted querier. Accordingly, when the query 604 is sent by the somewhat-trusted government employee 608, the QADP system 102 may determine to balance privacy and accuracy. Accordingly, upon receiving a results dataset associated with the query 604, the QADP system may introduce a moderate amount (“some”) of noise into the results dataset and return the results 614 with some introduced noise. In this manner, the results 614 may provide an increased level of privacy over results 612, while providing less accuracy than results 612.

The public user 610 may be identified as an untrusted querier and/or there may be no trust information associated with this type of user. Accordingly, when the query 604 is sent by the untrusted public user 610, the QADP system 102 may determine to prioritize privacy over accuracy. Accordingly, upon receiving a results dataset associated with the query 604, the QADP system may introduce a large amount of noise into the results dataset and return the results 616 with a large amount of introduced noise. In this manner, the results 616 may provide an increased level of privacy over results 612 and results 614, while providing less query accuracy than results 612 and results 614.

Taking a look now at the effects of query leakage, an illustration of a common querier (e.g., public user 610) providing two queries, a no leak query 618 and a sensitive query (e.g., data leaking query) 620 is provided. Upon identifying the no leak query 618 as a query that does not leak data, the QADP System 102 may determine that no noise need be introduced into the results dataset of the no leak query 618. Accordingly, results dataset 622 without added differential privacy noise is provided back to the public user 610, despite the public user not being a trusted querier. However, based upon identifying that the sensitive query 620 may leak data, the QADP System 102 may determine a custom-tailored amount of noise to introduce into the results dataset of the sensitive query 620. The custom-tailored amount of noise is introduced into the results dataset 624 and provided back to the public user 610.

As may be appreciated, the current techniques provide significant value. For example, the current technique provide more flexible differential privacy, balancing a tradeoff between data privacy and query accuracy for particular applications and/or queries.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A non-transitory, computer-readable medium, comprising computer-readable instructions that, when executed by one or more processors of one or more computers, cause the one or more computers to:
receive, from a querier, a data query;
identify a query characteristic of the data query;
identify an amount of noise to introduce to results of the data query based upon the query characteristics;
generate query-adapted differential privacy (QADP) results corresponding to the data query, by introducing the amount of noise into the results of the data query; and
provide the QADP results to the querier.

2. The non-transitory, computer-readable medium of claim 1, comprising computer-readable instructions that, when executed by the one or more processors of the one or more computers, cause the one or more computers to:
identify an amount of private information leakage provided by unmodified results of the data query as the query characteristic.

3. The non-transitory, computer-readable medium of claim 2, comprising computer-readable instructions that, when executed by the one or more processors of the one or more computers, cause the one or more computers to:
when there is no private information leakage provided by the unmodified results of the data query, identify the amount of noise to introduce to the data query as none.

4. The non-transitory, computer-readable medium of claim 1, comprising computer-readable instructions that, when executed by the one or more processors of the one or more computers, cause the one or more computers to:
identify a level of trust of the querier as the query characteristic.

5. The non-transitory, computer-readable medium of claim 4, comprising computer-readable instructions that, when executed by the one or more processors of the one or more computers, cause the one or more computers to:
when the querier is trusted, identify the amount of noise to introduce to the data query as none.

6. The non-transitory, computer-readable medium of claim 1, comprising computer-readable instructions that, when executed by the one or more processors of the one or more computers, cause the one or more computers to:
identify a sensitivity of the data query as the query characteristic.

7. The non-transitory, computer-readable medium of claim 6, comprising computer-readable instructions that, when executed by the one or more processors of the one or more computers, cause the one or more computers to:
identify the amount of noise to introduce to the data query as a function of the sensitivity of the data query.

8. The non-transitory, computer-readable medium of claim 6, comprising computer-readable instructions that, when executed by the one or more processors of the one or more computers, cause the one or more computers to identify the sensitivity of the data query, by:
sampling a dataset associated with the data query to identify candidate item sets;
generate adjacent datasets to the dataset by modifying the candidate item sets; and
determining a sensitivity metric based upon identified differences between results obtained by applying the data query to the dataset and the adjacent datasets.

9. The non-transitory, computer-readable medium of claim 8, wherein the sensitivity metric comprises a global sensitivity determined by identifying a maximum difference of the identified differences.

10. The non-transitory, computer-readable medium of claim 8, wherein the sensitivity metric comprises an average sensitivity determined by identifying an average difference of the identified differences.

11. A computer-implemented method, comprising:
receiving a data query from a querier; and
at query-time, perform query-adapted differential privacy (QADP), by:
determining at least one of: whether the querier is trusted or whether the data query leaks data;
when the querier is trusted, the data query does not leak data, or both, processing the data query without noise added for differential privacy to preserve query accuracy of query results of the data query; and
when the querier is not trusted and the data query leaks data:
evaluating the data query to identify a sensitivity metric of the data query;
calculating an amount of noise to be added to provide a level of privacy corresponding to the sensitivity metric; and
generating and process a QADP results dataset by incorporating the amount of noise to the query results to provide the level of privacy corresponding to the sensitivity metric.

12. The computer-implemented method of claim 11, comprising:
identifying the sensitivity metric of the data query, by:
applying the data query to a dataset and to a plurality of modified datasets;
identifying a magnitude of difference between the data query applied to the dataset and the data query applied to the plurality of modified datasets; and
calculating the sensitivity metric as a function of the magnitude of difference.

13. The computer-implemented method of claim 11, comprising calculating the level of privacy based in part upon a user-provided recommendation indicating a recommended level of privacy for the data query.

14. The computer-implemented method of claim 11, comprising determining that the querier is trusted based upon the querier being a data owner of a data source that the data query is applied to.

15. The computer-implemented method of claim 11, comprising receiving the data query from the querier by intercepting the data query from a submission to a data source that the data query is to be applied to.

16. The computer-implemented method of claim 11, comprising:
in response to identifying that the querier is not trusted and the data query leaks data, identifying a type of the noise to be added from one of: Gaussian noise and Laplacian Noise.

17. A system comprising:
a database comprising a dataset; and
a query-adapted differential privacy (QADP) system, comprising one or more computer processors configured to:
receive a data query, the data query comprising a request for a results dataset from the dataset; and
perform QADP, by:
identifying a query characteristic of the data query;
identifying an amount of noise to introduce to the results dataset based upon the query characteristics;
generating query-adapted differential privacy (QADP) results corresponding to the data query, by introducing the amount of noise into the results dataset; and
providing the QADP results to a querier providing the data query.

18. The system of claim 17, wherein the one or more computer processors of the QADP system are configured to perform the QADP, by:
identifying a trust level associated with the querier; and
dynamically identifying the amount of noise to introduce based upon the trust level associated with the querier.

19. The system of claim 17, wherein the one or more computer processors of the QADP system are configured to perform the QADP, by:
identifying a sensitivity associated with the data query; and
dynamically identifying the amount of noise to introduce based upon the sensitivity associated with the data query.

20. The system of claim 17, wherein the one or more computer processors of the QADP system are configured to perform the QADP, by:
identifying a user-provided privacy level recommendation; and
dynamically identifying the amount of noise to introduce based upon the user-provided privacy level recommendation.
